(19) United States
(12) Patent Application Publication
(10) Pub. No.: US 2025/0371326 A1
(43) Pub. Date: Dec. 4, 2025

(54) HYBRID VISION BACKBONE ARCHITECTURE COMBINING SELECTIVE STATE SPACE MODEL BLOCKS AND TRANSFORMER BLOCKS

(71) Applicant: NVIDIA Corporation, Santa Clara, CA (US)

(72) Inventors: Ali Hatamizadeh, Los Angeles, CA (US); Jan Kautz, Lexington, MA (US)

(21) Appl. No.: 19/039,576

(22) Filed: Jan. 28, 2025

Related U.S. Application Data
(60) Provisional application No. 63/653,117, filed on May 29, 2024.

(51) Int. Cl. G06N 3/048

(52) U.S. Cl. CPC G06N 3/048

(57) ABSTRACT

Neural network architectures for feature extraction from visual input. In at least one embodiment, a neural network architecture for a vision backbone includes hybrid stages with at least one state space model (SSM)-based block preceding at least one transformer block. In at least one embodiment, an SSM-based block includes parallel branches, one including an SSM and one without an SSM, and a concatenation layer for concatenating the output of each branch. In at least one embodiment, the SSM performs a parallel selective scan operation to efficiently map tokens of an input sequence to tokens of an output sequence via GPU acceleration.

### CLAIM OF PRIORITY

This application claims the benefit of U.S. Provisional Application No. 63/653,117 (Attorney Docket No. 514881) titled “Mamba Vision: A Hybrid Mamba-Transformer Vision Backbone,” filed May 29, 2024, the entire contents of which are incorporated herein by reference.

### FIELD

The present disclosure relates to neural network architectures and, in particular, to neural network architectures for feature extraction from visual input.

### BACKGROUND

During recent years, transformer models have become the de facto neural network architecture in a variety of different domains including, for example, computer vision, natural language processing, speech processing, and robotics. The versatility and flexibility of the transformer architecture make transformer models highly suitable for multimodal learning tasks. Nevertheless, transformer models are computationally expensive to train and deploy due to the quadratic complexity of their attention mechanism. For a sequence with a length of L tokens, the attention mechanism requires calculating interactions between all pairs of tokens such that the computational complexity increases quadratically with respect to the length L.

Recently, a new state space model (SSM) architecture (see Albert Gu and Tri Dao, Mamba: Linear-time sequence modeling with selective state spaces, arXiv preprint arXiv:2312.00752, 2023, hereinafter referred to as “Mamba,” the entire contents of which are incorporated herein by reference) has been developed. The core component of the Mamba architecture is a novel selection mechanism (i.e., the selective scan operation described in Mamba) that enables efficient input-dependent processing of long sequences with hardware-aware considerations. The Mamba architecture is able to selectively focus on relevant information within sequences, filter out less important data, and adapt its processing based on the input. The primary advantage of the Mamba architecture is computational efficiency: as compared to the quadratic computational complexity of the transformer, the computational complexity of the Mamba architecture increases only linearly with respect to the length of an input sequence. Furthermore, the amount of memory required by the Mamba architecture is similarly reduced as compared to that required by the transformer architecture. As a result of these advantages, the Mamba architecture can model long sequences more efficiently than the transformer architecture, offering improvements in speed, memory consumption, scalability, and performance for a variety of different applications.

Recently, a number of Mamba-based backbones have been developed to leverage the strengths of the Mamba architecture for vision tasks, e.g., image classification and semantic segmentation. However, the autoregressive formulation of the Mamba architecture—while effective for tasks requiring sequential data processing, faces limitations in computer vision tasks that benefit from a full receptive field. Unlike sequences of text (where order matters), image pixels do not have a sequential dependency. Spatial relationships are often local, and image regions (e.g., pixels) need to be considered in a more parallel and integrated manner. As a result, the Mamba architecture exhibits certain inefficiencies in processing spatial data. Furthermore—due to its autoregressive formulation—the Mamba architecture processes data in a step-by-step fashion. As a result, the Mamba architecture is limited in its ability to capture and utilize global context—which is often required by vision tasks to make accurate predictions about local image regions.

### BRIEF DESCRIPTION OF THE DRAWINGS

Systems and methods of the present disclosure are described herein below with reference to the attached drawing figures, wherein:

FIG. 1A illustrates the architecture of an SSM-based block, according to an embodiment;

FIG. 1B provides an algorithm which an SSM-based block is, according to an embodiment, configured to execute;

FIG. 2 illustrates a hybrid vision backbone architecture according to an embodiment;

FIG. 3 illustrates Top-1 accuracy vs. image throughput for a variety of different vision backbones, including vision backbones having a hybrid vision backbone architecture according to an embodiment;

FIG. 4 is a conceptual diagram of a processing system implemented using a PPU, suitable for use in implementing some embodiments of the present disclosure.

FIG. 5A illustrates an exemplary system in which the various architecture and/or functionality of the various previous embodiments may be implemented.

FIG. 5B illustrates components of an exemplary system that can be used to train and utilize machine learning, in at least one embodiment.

FIG. 6 illustrates an exemplary streaming system suitable for use in implementing some embodiments of the present disclosure.

### DETAILED DESCRIPTION

Systems and methods are disclosed herein that relate to neural network backbones for computer vision applications, i.e., vision backbones. Systems and methods are disclosed herein that provide novel vision backbone architectures that combine both state space model (SSM)-based blocks and transformer blocks. The hybrid vision backbone architectures disclosed herein demonstrate substantial improvements in performance over state-of-the-art vision backbones. In at least one embodiment, the SSM-based blocks themselves have novel architectures tailored for vision applications.

The systems and methods described herein may be used by, without limitation, non-autonomous vehicles, semi-autonomous vehicles (e.g., in one or more advanced driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations, systems implemented using large language models (LLMs), systems implemented using vision language models (VLMs), systems for performing light transport simulation, systems for performing collaborative content creation for 3D assets, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The present disclosure provides systems and methods for extracting features from visual input, e.g., images. According to a first aspect, the present disclosure provides a novel architecture for a state space model (SSM)-based block. The novel architecture provides an SSM-based block suitable for integration into a broader neural network architecture, e.g., into a vision backbone. The SSM-based block is, in particular a vision-friendly SSM-based block. In at least one embodiment, the SSM-based block incorporates a parallel selective scan operation to enable efficient input-dependent processing of long sequences with hardware-aware considerations. In at least one embodiment, the parallel selective scan operation is the selective scan operation described by Mamba, and the SSM-based block is referred to as a “Mamba Vision” block. In at least one embodiment, the SSM-based block includes two parallel branches: (i) a first branch comprising an SSM—for providing a local, pixelwise understanding of an image; and (ii) a second branch without an SSM—for providing a global understanding of the image. In at least one embodiment, the output of the first branch and the output of the second branch are concatenated by a concatenation layer. The novel architecture for the SSM-based block provides improved accuracy and image throughput in vision-related tasks—as compared to either traditional Mamba blocks or traditional transformer blocks.

According to a second aspect, the present disclosure provides a novel architecture for a vision backbone, the novel architecture being a hybrid architecture that combines both (i) SSM-based blocks and (ii) transformer blocks. In at least one embodiment, the SSM-based blocks have the novel architecture according to the first aspect (e.g., a Mamba Vision block). In at least one embodiment, a multi-layer perceptron (MLP) is appended to the SSM-based blocks. In at least one embodiment, input to each transformer block is downstream of the SSM-based blocks, and no positional embedding is appended to the input tokens of the transformer blocks.

According to a third aspect, the present disclosure provides methods for extracting features from visual input via a vision backbone comprising an SSM-based block with the architecture according to the first aspect or via a vision backbone with the architecture according to the second aspect.

According to embodiments, a system includes processing circuitry configured to use one or more neural networks to perform inference. The one or more neural networks include a state space model (SSM)-based block. The SSM-based block includes a first branch comprising an SSM, a second branch without an SSM, and a concatenation layer configured to concatenate an output of the first branch and an output of the second branch. The system further includes one or more memories to store the neural network. According to embodiments, a method is provided for extracting, using the system (including any embodiment thereof), features from visual input, e.g., in the form of an image or video.

According to an embodiment of the system, the SSM is configured to perform a scan operation that maps a respective token in a sequence of tokens provided to the SSM as input to a respective token in a sequence of tokens provided by the SSM as output via a respective hidden state. According to an embodiment, the scan operation is a selective scan operation in which parameters of the respective hidden state are determined based on the respective input token. According to an embodiment, the selective scan operation maps the sequence of input tokens to the sequence of output tokens via a hidden state according to h(t)=Āh(t−1)+B̅x(t) and y(t)=C̅h(t), where x(t) is the sequence of input tokens, y(t) is the sequence of output tokens, h(t) is a sequence of latent states, Ã=exp(ΔA), B̅=(ΔA)⁻¹ (exp(ΔA)−I)·(ΔB), and the parameters B, C, and Δ are input-dependent.

According to an embodiment of the system, the first branch further includes a first linear projection layer, a first convolutional layer, and a first activation function. According to an embodiment of the system, the first linear projection layer is configured to receive SSM-based block input and project the SSM-based block input into a latent space to provide first linear projection layer output, the first convolutional layer is configured to receive the first linear projection layer output and apply a convolutional filter thereto to provide first convolutional layer output, the first activation function is configured to receive the first convolutional layer output and apply a non-linear transformation to each element thereof to provide a sequence of tokens, and the SSM is configured to receive the sequence of tokens as input and to provide a second sequence of tokens that are provided as the output of the first branch.

According to an embodiment of the system, the second branch further includes a second linear projection layer, a second convolutional layer, a second activation function. According to an embodiment of the system, the second linear projection layer is configured to receive the SSM-based block input and project the SSM-based block input into a latent space to provide second linear projection layer output, the second convolutional layer is configured to receive the second linear projection layer output and apply a convolutional filter thereto to provide second convolutional layer output, and the second activation function is configured to receive the second convolutional layer output and apply a non-linear transformation to each element thereof to provide a third sequence of tokens that are provided as the output of the second branch.

According to an embodiment of the system, the SSM-based block further comprises a third linear projection layer configured to receive the output of the concatenation layer and reduce the dimensionality of the output of the concatenation layer.

According to an embodiment of the system, the SSM-based block is configured to receive SSM-based block input and provide SSM-based block output according to

$${X}_{1} = Scan ( σ ( Conv ( Linear ( C , \frac{c}{2} ) ( {X}_{i n} ) ) ) ) ,$$

$${X}_{2} = σ ( Conv ( Linear ( C , \frac{c}{2} ) ( {X}_{i n} ) ) ) , and$$

$${X}_{out} = Linear ( \frac{c}{2} , C ) ( Concat ( {X}_{1} , {X}_{2} ) ) ,$$

wherein Xᵢₙ is the SSM-based block input, Xₒᵤₜ is the SSM-based block output, Linear (Cᵢₙ, Cₒᵤₜ) denotes a linear layer with input embedding dimension Cᵢₙ and output embedding dimension Cₒᵤₜ, Scan(·) is the selective scan operation, σ is an activation function, Conv(·) is a 1D convolution operation, and Concat(·) is a concatenation operation.

According to embodiments, a system includes processing circuitry configured to use one or more neural networks to extract features from visual input, the one or more neural networks including at least one hybrid stage comprising one or more state space model (SSM)-based blocks and one or more transformer blocks, wherein at least one SSM-based block precedes at least one transformer block. According to embodiments, a method is provided for extracting, using the system (including any embodiment thereof), features from visual input, e.g., in the form of an image or video.

According to an embodiment of the system, the one or more neural networks are configured to receive, as input, the visual input and to provide, as output, a sequence of tokens encoding feature information.

According to an embodiment of the system, the one or more neural networks include one or more second hybrid stages comprising one or more additional state space model (SSM)-based blocks and one or more additional transformer blocks, wherein at least one additional SSM-based block precedes at least one additional transformer block.

According to an embodiment of the system, the at least one hybrid stage is configured to process the visual input at a first resolution, and the at least one second hybrid stage is configured to process the visual input at a second resolution.

According to an embodiment of the system, the at least one SSM-based block is configured to perform a scan operation that maps a respective token in a sequence of input tokens to a respective token in a sequence of output tokens via a respective hidden state, wherein the respective sequence of output tokens encodes positional information, and wherein the at least one transformer block receives the sequence of output tokens as input.

According to an embodiment of the system, no positional embedding is appended to the sequence of output tokens prior to their being received by the at least one transformer block as input.

According to an embodiment of the system, the at least one SSM-based block includes a first branch including an SSM, a second branch without an SSM, and a concatenation layer configured to concatenate an output of the first branch and an output of the second branch. According to an embodiment of the system, the SSM is configured to perform a scan operation that maps a respective token in a sequence of tokens provided to the SSM as input to a respective token in a sequence of tokens provided by the SSM as output via a respective hidden state. According to an embodiment of the system, the scan operation is a selective scan operation in which parameters of the respective hidden state are determined based on the respective input token.

According to an embodiment of the system, the SSM-based block is configured to receive SSM-based block input and provide SSM-based block output according to

$${X}_{1} = Scan ( σ ( Conv ( Linear ( C , \frac{c}{2} ) ( {X}_{i n} ) ) ) ) ,$$

$${X}_{2} = σ ( Conv ( Linear ( C , \frac{c}{2} ) ( {X}_{i n} ) ) ) , and$$

$${X}_{out} = Linear ( \frac{c}{2} , C ) ( Concat ( {X}_{1} , {X}_{2} ) ) ,$$

wherein Xᵢₙ is the SSM-based block input, Xₒᵤₜ is the SSM-based block output, Linear (Cᵢₙ, Cₒᵤₜ) denotes a linear layer with input embedding dimension Cᵢₙ and output embedding dimension Cₒᵤₜ, Scan(·) is the selective scan operation, σ is an activation function, Conv(·) is a 1D convolution operation, and Concat(·) is a concatenation operation.

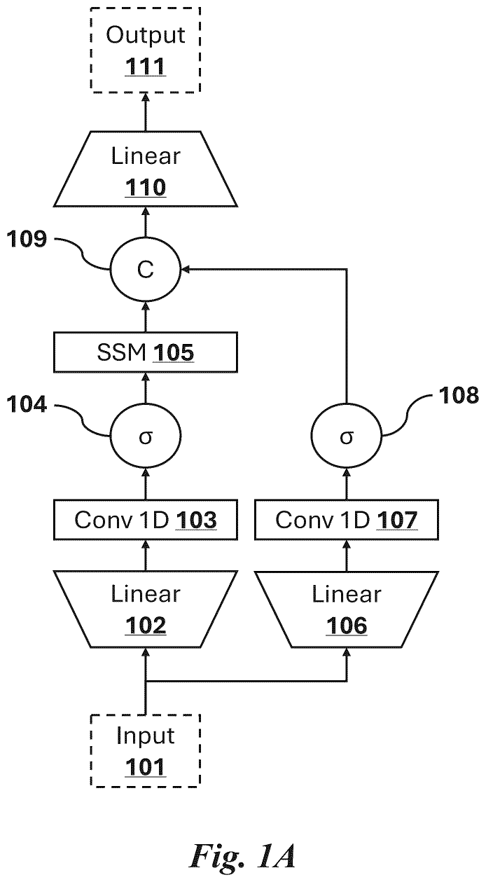

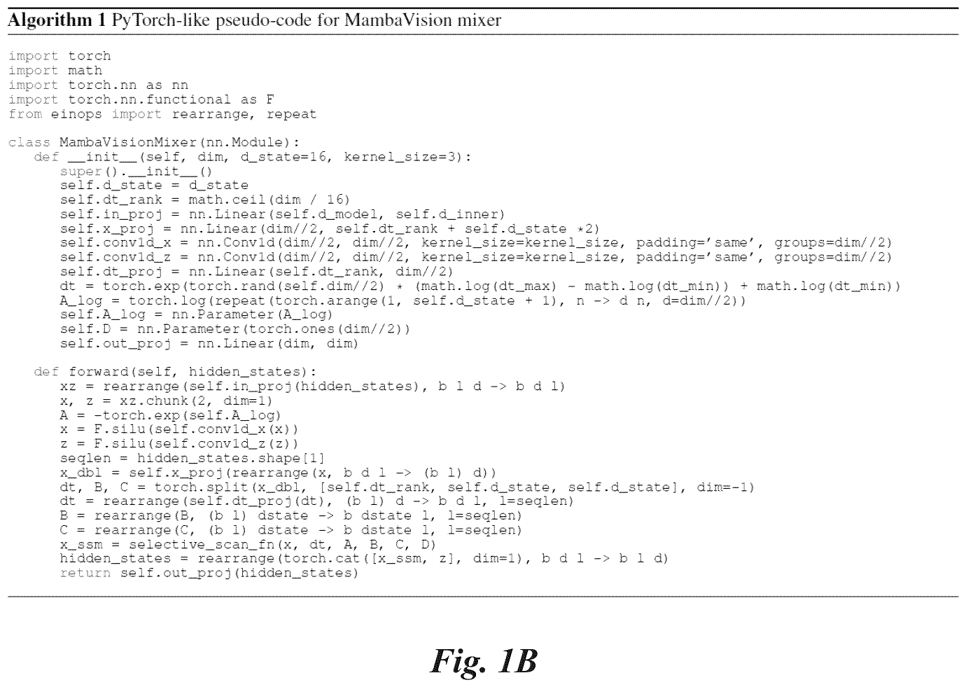

FIG. 1 illustrates a state space model (SSM)-based block architecture according to an embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

FIG. 1A illustrates the architecture of an SSM-based block 100 according to an embodiment. SSM-based block 100 receives input 101 and provides the input 101 to both (i) a first branch with an SSM—for providing a local, pixelwise understanding of an image; and (ii) a second branch without an SSM—for providing a global understanding of the image. The input 101 is provided in the form of a sequence of tokens, each of which corresponds to a patch of an image. The tokens are produced, e.g., from a tokenization process in which (i) the image is divided into a plurality of fixed size patches, and (ii) each patch is linearly projected into a d-dimensional space to form a token. For example, for a 2D image of size H×W×C, where H and W represent the height and width of the image (e.g., 224×224 pixels) and C is the number of channels (e.g., 3 in the case of RGB), the image can be divided into patches of K×K resolution (e.g., 16×16 pixels), resulting in

$$\frac{H \times W}{{K}^{2}}$$

patches (e.g., 196 patches), each of which is projected into the d-dimensional space (e.g., d=128) to form the tokens (e.g.,

$$\frac{H \times W}{{K}^{2}} = 196 tokens ) .$$

The first branch of the SSM-based block 100 includes a first linear projection layer 102, which receives the input 101 (i.e., the sequence of tokens) and projects it into a new embedding space. In at least one embodiment, the first linear projection layer 102 halves the dimensionality of each of the tokens, thereby producing a sequence of

$$\frac{H \times W}{{K}^{2}}$$

tokens of dimensionality

$$\frac{d}{2} .$$

The output of the first linear projection layer 102 is provided to a one-dimensional convolutional layer 103 that applies a sliding convolutional filter thereto. The output of the one-dimensional convolutional layer 103 is provided to a non-linear activation function (e.g., a SiLU activation function) 104, and the output of the non-linear activation function is provided to learnable SSM 105.

Learnable SSM 105 performs a scan operation that maps each token in an input sequence x to a token in an output sequence y through a hidden state h. In at least one embodiment, hidden state h (which can also be referred to as a latent state) is a selective state that is updated each time a new input token in the input sequence x is processed, thereby providing an internal state that selectively retains information about prior hidden states based on (i) the current input token being processed and (ii) time-variant parameters corresponding to the current input token being processed. With respect to (ii), the time-variant parameters are determined in parallel for all tokens in the input sequence by applying, to the input sequence x, learned projections (which are trained and optimized during the model's training phase). In this manner, each output token in the output sequence y (which corresponds to a respective input token in the input sequence x) is determined in an autoregressive fashion, i.e. by selectively considering information from the collection of input tokens that precede the corresponding respective input token. In at least one embodiment, learnable SSM 105 performs a GPU-efficient, parallel selective scan operation that maps the input sequence to the output sequence. In at least one embodiment, learnable SSM 105 performs the selective scan operation of Mamba. The output of the learnable SSM 105 (e.g., a sequence of

$$\frac{H \times W}{{K}^{2}}$$

tokens of dimensionality

$$\frac{d}{2} )$$

is when provided to concatenation layer 109.

In at least one embodiment, learnable SSM 105 maps 1D continuous input x(t)∈ [symbol] to continuous 1D output y(t)∈ [symbol] , via a learnable hidden state h(t)∈ [symbol] M with parameters A∈ [symbol] ^{M×M}, B∈ [symbol] ^{M×1}, and C∈ [symbol] ^{1×M} according to:

$$\begin{matrix}{h}^{′} ( t ) = A h ( t ) + Bx ( t ) , \\ y ( t ) = Ch ( t ) .\end{matrix}$$

In at least one embodiment, continuous parameters A, B, and C are converted into discrete parameters for improved computational efficiency. In at least one embodiment, assuming a timescale Δ, a zero-order hold rule is applied to obtain discrete parameters Ã∈ [symbol] ^{M×M}, B̅∈ [symbol] ^{M×1}, and C̅∈ [symbol] ^{1×M} according to:

$$\begin{matrix}\overline{A} = exp ( Δ A ) , \\ \overline{B} = {( Δ A )}^{- 1} ( exp ( Δ A ) - I ) \cdot ( Δ B ) , \\ \overline{C} = C .\end{matrix}$$

The learnable hidden state h(t) and the output y(t) can then be expressed with discrete parameters as:

$$\begin{matrix}{h}^{′} ( t ) = \overline{A} h ( t ) + \overline{B} x ( t ) , \\ y ( t ) = \overline{C} h ( t ) .\end{matrix}$$

In addition, for an input sequence with size T, a global convolution with kernel K can be applied for computing the output y(t) according to:

$$\begin{matrix}K = ( C \overline{B} , C \overline{AB} , , C {\overline{A}}^{T - 1} \overline{B} ) , \\ y = x * \overline{K} ,\end{matrix}$$

In at least one embodiment, learnable SSM 105 maps 1D continuous input x(t)∈ [symbol] to continuous 1D output y(t) E R using a selective scan operation that includes a selection mechanism that allows for input-dependent sequence processing. As a result, the parameters B, C and Δ can be adjusted dynamically according to the inputs and irrelevant information can be filtered out. In at least one embodiment, the selective scan operation is a parallel selective scan operation. In at least one embodiment, the selective scan operation is the selective scan operation described in Albert Gu and Tri Dao, Mamba: Linear-time sequence modeling with selective state spaces, arXiv preprint arXiv:2312.00752, 2023—which is incorporated by reference herein.

The second branch of the SSM-based block 100 includes a second linear projection layer 106, which receives input 101 and projects it into a new embedding space with the same size as the new embedding space into which projection layer 102 projects input 101, enabling the capture of more complex patterns. The output of the second linear projection layer 106 is provided to a one-dimensional convolutional layer 107 that applies sliding convolutional filters thereto. The output of the one-dimensional convolutional layer 107 is provided to a non-linear activation function (e.g., a SiLU activation function) 108, and the output of the non-linear activation function (e.g., a sequence of

$$\frac{H \times W}{{K}^{2}}$$

tokens of dimensionality

$$\frac{d}{2} )$$

is provided to concatenation layer 109.

Concatenation layer 109 concatenates the output of the first branch (i.e. the output of learnable SSM 105) and the output of the second branch (i.e. the output of non-linear activation function 108) and provides the output to linear projection layer 110, which is configured to receive the output of concatenation layer 109. The output of linear projection layer 110 is the output of the SSM-based block 100, i.e. output 111 (e.g., a sequence of

$$\frac{H \times W}{{K}^{2}}$$

tokens of dimensionality d).

In at least one embodiment, SSM-based block 100 receives input 101, represented by Xᵢₙ, and provides output 111, represented by Xₒᵤₜ and computed according to:

$$\begin{matrix}{X}_{1} = Scan ( σ ( Conv ( Linear ( C , \frac{C}{2} ) ( {X}_{in} ) ) ) ) , \\ {X}_{2} = σ ( Conv ( Linear ( C , \frac{C}{2} ) ( {X}_{in} ) ) ) , \\ {X}_{out} = Linear ( \frac{C}{2} , C ) ( Concat ( {X}_{1} , {X}_{2} ) ) ,\end{matrix}$$

where Linear (Cᵢₙ, Cₒᵤₜ)(·) denotes a linear layer with Cᵢₙ and Cₒᵤₜ as input and output embedding dimensions, Scan(·) is the selective scan operation described in Mamba, and σ is the activation function, e.g., SiLU. In addition, Conv(·) and Concat(·) represent 1D convolution and concatenation operations, respectively.

In at least one embodiment, SSM-based block 100 is configured to execute the algorithm provided in FIG. 1B.

SSM-based block 100 provides for improved accuracy and image throughput in vision-related tasks—as compared to either a traditional Mamba block or a traditional transformer block. As compared to the traditional Mamba block, SSM-based block 100 eliminates certain causal architectural components, which are unnecessary and overly restrictive for vision-related tasks, and provides a parallel branch without SSM, thereby compensating for content lost due to sequential constraints inherent to SSM. The architecture of SSM-based block 100 ensures that the feature representation provided as output incorporates both sequential and spatial information, leveraging the strengths of both branches. The architecture of SSM-based block 100 provides computational complexity that scales only linearly with respect to the length of the input sequence while also enhancing global context representation learning capability.

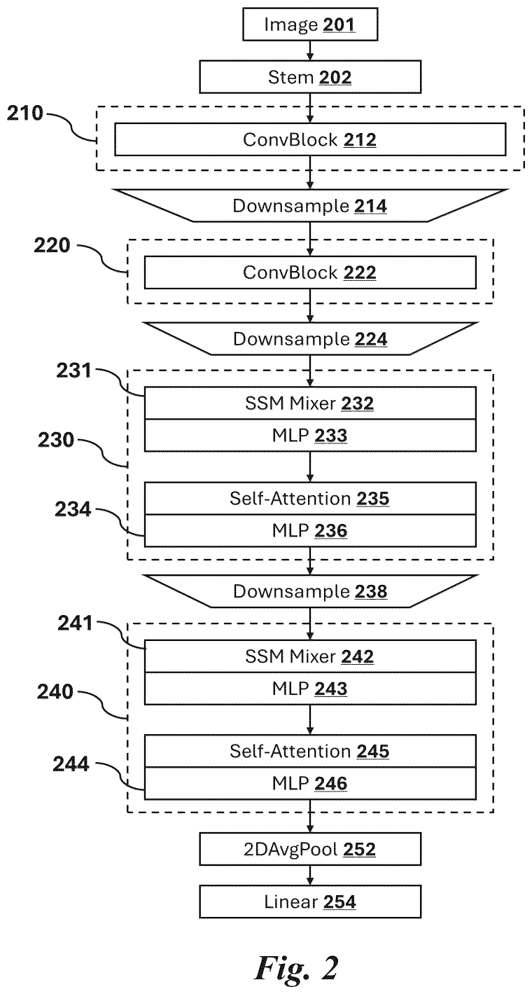

FIG. 2 illustrates a hybrid vision backbone architecture according to an embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

FIG. 2 illustrates the architecture of hybrid vision backbone 200. The architecture of hybrid vision backbone 200 is a four stage architecture. The stem 205, the first stage 210, and the second stage 220 include convolutional neural network-based layers for fast feature extraction at higher input resolutions. The third stage 230 and the fourth stage 240 each include a combination of a plurality of SSM-based blocks and Transformer blocks for performing image segmentation, classification, and/or alternative computer vision tasks. Vision backbone 200 further includes downsampling layers 214, 224, and 238 between each pair of consecutive stages and a 2D average pooling layer 252 and a linear output layer 254.

Hybrid vision backbone 200 is configured to receive, as input, an image 201. The image 201 has, e.g., size H×W×3. The stem 202 divides the input image into a plurality of patches, each having, e.g., size K×K, and provides a feature map that provides an embedding vector for each image patch of image 201. In at least one embodiment, stem 202 converts image 201 into overlapping patches with size

$$\frac{H}{4} \times \frac{W}{4}$$

(i.e., here K=4 such that each patch includes 16 pixels) and projects each patch into a C dimensional embedding space. The result is an input, to the first stage 210, of a feature map with size

$$\frac{H}{4} \times \frac{W}{4} \times C .$$

The first stage 210 includes N₁ generic residual convolutional blocks 212 and is followed by a downsampler 214 to reduce the resolution by half, thereby providing an input, to the second stage 220, of a feature map with size

$$\frac{H}{8} \times \frac{W}{8} \times 2 C .$$

Each of the generic residual convolutional blocks includes a convolutional layer, an activation layer, and a batch normalization layer. In at least one embodiment, the activation layer applies the Gaussian Error Linear Unit (GELU) activation function \ddot{z}=GELU(BN(Conv_{3×3}(z))), and the batch normalization layer normalizes the input according to z=BN(Conv_{3×3}(z))+z.

The second stage 220 includes N₂ generic residual convolutional blocks 222 and is followed by a downsampler 224 to again reduce the resolution by half, thereby providing an input, to the third stage 230, of a feature map with size

$$\frac{H}{16} \times \frac{W}{16} \times 4 C .$$

Each of the generic residual convolutional blocks includes a convolutional layer, an activation layer, and a batch normalization layer. In at least one embodiment, the activation layer applies the Gaussian Error Linear Unit (GELU) activation function \hat{z}=GELU(BN(Conv_{3×3}(z))), and the batch normalization layer normalizes the input according to z=BN(Conv_{3×3}(z))+z.

In at least one embodiment, the input image 201 has a size of 224×224 pixels, each pixel having 3 channels for RGB, then the stem 202 provides a feature map of 56×56 16-pixel patches, each patch represented by a C-dimensional embedding vector, the first stage 210 and the downsampler 214 provide a feature map of 28×28 64-pixel patches, each patch represented by a 2C-dimensional embedding vector, and the second stage 220 and the downsampler 224 provide a feature map of 14×14 256-pixel patches, each patch represented by a 4C-dimensional embedding vector.

The third stage 230 is a hybrid stage that includes N₃ blocks, the hybrid stage including

$$\frac{{N}_{3}}{2}$$

SSM-based blocks 231 and

$$\frac{{N}_{3}}{2}$$

transformer blocks 234. Each SSM-based block 231 includes an SSM-mixer component 232 and a multi-layer perceptron (MLP) 233. In at least one embodiment, SSM-mixer component 232 is the SSM-based block 100 of FIG. 1A. Each transformer block 234 includes a multi-head attention (MHA) sub-block 235 and an MLP 236. The third stage 230 receives, as input, a feature map with the size

$$\frac{H}{16} \times \frac{W}{16} \times 4 C$$

and reshapes the input by flattening the height and width dimensions to provide a sequence of

$$\frac{H}{16} \times \frac{W}{16}$$

tokens, each token being a 4C-dimensional embedding vector. For example, if the input image 201 has a size of 224×224 pixels and C=32, the third stage 230 reshapes a feature map for a 14×14 arrangement of image patches into a sequence of 196 tokens, each token being a 128-dimensional embedding vector. The sequence of 196 tokens is processed sequentially by each of the

$$\frac{{N}_{3}}{2}$$

SSM-based blocks 231 then by each of the

$$\frac{{N}_{3}}{2}$$

transformer blocks 234. The third stage is followed by a downsampler 238 to again reduce the resolution in half, thereby providing an input, to the fourth stage 240, of a feature map with size

$$\frac{H}{32} \times \frac{W}{32} \times 8 C .$$

The fourth stage 240 is a hybrid stage that includes N₄ blocks, the hybrid stage including

$$\frac{{N}_{4}}{2}$$

SSM-based blocks 241 and

$$\frac{{N}_{4}}{2}$$

transformer blocks 244. Each SSM-based block 241 includes an SSM-mixer component 242 and a multi-layer perceptron (MLP) 243. The SSM-mixer component 242 is, e.g., the SSM-based block 100 of FIG. 1A. Each transformer block 244 includes a multi-head attention (MHA) sub-block 245 and an MLP 246. The fourth stage 240 receives, as input, a feature map with the size

$$\frac{H}{32} \times \frac{W}{32} \times 8 C$$

and reshapes the input by flattening the height and width dimensions to provide a sequence of

$$\frac{H}{32} \times \frac{W}{32}$$

tokens, each token being an 8C-dimensional embedding vector. For example, if the input image 201 has a size of 224×224 pixels and C=32, the fourth stage 230 reshapes a feature map for a 7×7 arrangement of image patches into a sequence of 49 tokens, each token being a 256-dimensional embedding vector. The sequence of 49 tokens is processed sequentially by each of the

$$\frac{{N}_{4}}{2}$$

SSM-based blocks 241 then by each of the

$$\frac{{N}_{4}}{2}$$

transformer blocks 244.

In a typical vision transformer, a positional embedding is added to each token in a sequence of tokens provided to each transformer block—i.e. to incorporate an ordering of the patches. However, in hybrid vision backbone 200, the output of the

$$\frac{{N}_{4}}{2} th$$

SSM-based block 231/the

$$\frac{{N}_{4}}{2} th$$

SSM-based block 241 can be provided directly to the first transformer block 234/244 without adding any positional embedding thereto. This is because each SSM-mixer component 232/242 incorporates an implicit positional encoding into its output.

Each MLP (i.e. MLP 233, MLP 236, MLP 243, and MLP 246) includes an input layer, an output layer, and one or more hidden layers. The input layer, the output layer, and each of the one or more hidden layers include a plurality of neurons. The input layer includes an input weight matrix, each hidden layer includes a respective hidden layer weight matrix, and the output layer includes an output layer weight matrix. The number of neurons in the input layer corresponds to the number of dimensions in the input data (i.e., in vision backbone 200, the dimensionality of the output of the SSM-mixer components 232/242 is the number of dimensions of input layer of MLP 233/243, and the dimensionality of the output of the MHA sub-block 235/245 is the number of dimensions of input layer of MLP 236/246). The hidden layers provide the MLP with the ability to ascertain complex patterns and relationships in the data it receives, and both the width (i.e. the number of neurons per hidden layer) and the depth (i.e. the number of hidden layers) impact the capacity of the MLP to learn and generalize from the data. Increasing the width and depth improves the accuracy of the inferences drawn by a model, but also increases the computational costs associated with both training the model and using the model at inference.

Each MHA sub-block (235, 245) includes a plurality of attention heads. Each respective attention head of the plurality of attention heads includes a respective set of three different learned weight matrices: (i) a query weight matrix for transforming an input vector into a query vector, (ii) a key weight matrix for transforming an input vector into a key vector, and (iii) a value weight matrix for transforming an input vector into a value vector. Each MHA sub-block (235, 245) provides context-aware representations corresponding to each token, thereby providing the ability to capture both global relationships between different tokens that correspond to different patches of an input image. In at least one embodiment, each MHA sub-block is configured to implement a generic multi-head self-attention (MHSA) mechanism according to:

$$Attention ( Q , K , V ) = Softmax ( \frac{{QK}^{T}}{\sqrt{{d}_{h}}} ) V ,$$

where Q, K, V denote query, key and value, respectively, and dₕ is the number of attention heads. In at least one embodiment, one or more MHA sub-blocks allow for computing attention in a windowed manner.

The combination of the 2D average pooling layer 252 and the linear layer 254 receives the output of the fourth stage 240, which is a feature map with the size

$$\frac{H}{32} \times \frac{W}{32} \times 8 C .$$

The combination of the 2D average pooling layer 252 and the linear layer 254 process and interpret the information extracted by the preceding first, second, third, and fourth stages in order to provide output in a format suitable for various downstream tasks, e.g. image segmentation and object detection. The 2D average pooling layer 252 performs a pooling operation that summarizes the features present in each local region of the image to provide a more compact, downsampled representation of the image content. The linear layer 254 can perform a linear transformation of the pooled features output by the 2D average pooling layer 252, adjust the dimensionality of the pooled features, produce a hierarchical representation of the pooled features, and/or perform a classification or regression task based on the pooled features.

According to an embodiment, hybrid vision backbone 200 is trained by performing a number of training iterations (e.g. N iterations), each training iteration including a forward pass, a loss calculation, and a backward pass. During the forward pass, the hybrid vision backbone 200 receives training instance input and processes it to generate output. During the loss calculation, the model output is processed to provide a model loss. During the backward pass, gradients with respect to the model loss are computed. In addition, each training iteration additionally includes a parameter update, in which parameters of learned layers of the network are updated, e.g. based on feedback provided during the backward pass. In at least one embodiment, the parameter update is performed as part of the backward pass. In at least one embodiment, the parameter update is performed after the backward pass of one training iteration and before the forward pass of the training iteration that immediately follows.

According to an embodiment, hybrid vision backbone 200 is be trained by performing a number of training iterations across a number of training steps, each training step including processing a batch of training examples, each training sample in the batch being processed via a single training iteration. In at least one embodiment, each training step includes processing a batch of training examples via plurality of training iterations and updating the prior set of parameters based on an average of gradients computed during each training iteration. During each training step, a set of instantaneous network parameters is provided by updating a prior set of parameters. In at least one embodiment, the prior set of parameters is updated using stochastic gradient descent (SGD), mini-batch gradient descent, or true gradient descent. In at least one embodiment, the prior set of parameters are updated using a gradient descent optimizer that utilizes momentum, adaptive learning rates, or adaptive moments (e.g. AdaGrad, RMSProp, Adam).

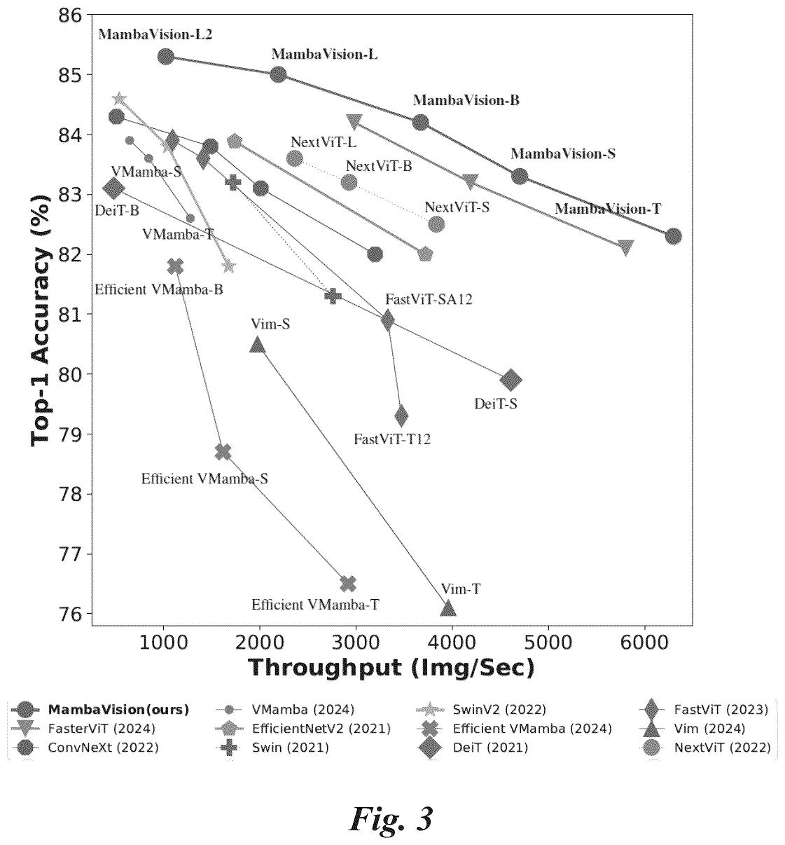

FIG. 3 illustrates Top-1 accuracy vs. image throughput for a variety of different vision backbones, including vision backbones having the architecture of hybrid vision backbone 200 illustrated in FIG. 2 (referred to herein as “MambaVision” variants). Top-1 accuracy is a performance metric (used to evaluate the effectiveness of vision transformers (ViTs) and other image classification models) that indicates the percentage of cases where the highest confidence prediction matches the correct label. For example, a ViT model achieving 88.55% top-1 accuracy on the ImageNet-1K dataset means the ViT model correctly identified the primary object or category in 88.55% of the test images in the dataset. Each of the variety of different vision backbones included in the results provided in FIG. 3 trained for 300 epochs using 32 A100 GPUs. The Mamba Vision models demonstrated best performance in both accuracy and throughput, establishing a new Pareto front for Top-1 accuracy vs. image throughput. The Mamba Vision variants outperform Mamba-based models such as VMamba and Vim, sometimes by a significant margin. For example, the MambaVision-B variant achieves higher accuracy (84.2%) compared to ConvNeXt-B (83.8%) and Swin-B (83.5%), while also having significantly better image throughput. Similar trends are observed in comparison to Mamba-based models. For example, the MambaVision-B (84.2%) variant outperforms VMamba-B (83.9%) while simultaneously providing considerably higher image throughput. Furthermore, Mamba Vision variants also exhibit much lower FLOPs compared to similarly-sized counterparts. For example, the Mamba Vision-B variant has 56% less GFLOPs than Max ViT-B. A comparison of classification benchmarks on the ImageNet-1K dataset are provided in Table 1 (image throughput is measured on an NVIDIA A100 GPU with a batch size of 128).

TABLE 1

| | | | | | |
|---|---|---|---|---|---|
| | Image Size | #Params | FLOPs | Throughput | Top-1 |
| Model | (Px) | (M) | (G) | (Img/Sec) | (%) |

Conv-Based

| | | | | | |
|---|---|---|---|---|---|
| ConvNeXt-T | 224 | 28.6 | 4.5 | 3196 | 82.0 |
| ConvNeXt-S | 224 | 50.2 | 8.7 | 2008 | 83.1 |
| ConvNeXt-B | 224 | 88.6 | 15.4 | 1485 | 83.8 |
| RegNetY-040 | 288 | 20.6 | 6.6 | 3227 | 83.0 |
| ResNetV2-101 | 224 | 44.5 | 7.8 | 4019 | 82.0 |
| EfficientNetV2-S | 384 | 21.5 | 8.0 | 1735 | 83.9 |

Transformer-Based

| | | | | | |
|---|---|---|---|---|---|
| Swin-T | 224 | 28.3 | 4.4 | 2758 | 81.3 |
| Swin-S | 224 | 49.6 | 8.5 | 1720 | 83.2 |
| SwinV2-T | 256 | 28.3 | 4.4 | 1674 | 81.8 |
| SwinV2-S | 256 | 49.7 | 8.5 | 1043 | 83.8 |
| SwinV2-B | 256 | 87.9 | 15.1 | 535 | 84.6 |
| TNT-S | 224 | 23.8 | 4.8 | 1478 | 81.5 |
| Twins-S | 224 | 24.1 | 2.8 | 3596 | 81.7 |
| Twins-B | 224 | 56.1 | 8.3 | 1926 | 83.1 |
| Twins-L | 224 | 99.3 | 14.8 | 1439 | 83.7 |
| DeiT-B | 224 | 86.6 | 16.9 | 2035 | 82.0 |
| DeiT3-L | 224 | 304.4 | 59.7 | 535 | 84.8 |
| PoolFormer-M58 | 224 | 73.5 | 11.6 | 884 | 82.4 |

Conv-Transformer

| | | | | | |
|---|---|---|---|---|---|
| CoaT-Lite-S | 224 | 19.8 | 4.1 | 2269 | 82.3 |
| CrossViT-S | 240 | 26.9 | 5.1 | 2832 | 81.0 |
| CrossViT-B | 240 | 105.0 | 20.1 | 1321 | 82.2 |
| Visformer-S | 224 | 40.2 | 4.8 | 3676 | 82.1 |
| NextViT-S | 224 | 31.7 | 5.8 | 3834 | 82.5 |
| NextViT-B | 224 | 44.8 | 8.3 | 2926 | 83.2 |
| NextViT-L | 224 | 57.8 | 10.8 | 2360 | 83.6 |
| EfficientFormer-L1 | 224 | 12.3 | 1.31 | 6220 | 79.2 |
| EfficientFormer-L3 | 224 | 31.4 | 3.9 | 2845 | 82.4 |
| EfficientFormer-L7 | 224 | 82.2 | 10.2 | 1359 | 83.4 |
| MaxViT-B | 224 | 120.0 | 23.4 | 507 | 84.9 |
| MaxViT-L | 224 | 212.0 | 43.9 | 376 | 85.1 |
| FasterViT-1 | 224 | 53.4 | 5.3 | 4188 | 83.2 |
| FasterViT-2 | 224 | 75.9 | 8.7 | 3161 | 84.2 |
| FasterViT-3 | 224 | 159.5 | 18.2 | 1780 | 84.9 |

Mamba-Based

| | | | | | |
|---|---|---|---|---|---|
| Vim-T | 224 | 7.0 | — | 3957 | 76.1 |
| Vim-S | 224 | 26.0 | — | 1974 | 80.5 |
| EfficientVMamba-T | 224 | 6.0 | 0.8 | 2904 | 76.5 |
| EfficientVMamba-S | 224 | 11.0 | 1.3 | 1610 | 78.7 |
| EfficientVMamba-B | 224 | 33.0 | 4.0 | 1482 | 81.8 |
| SiMBA-S | 224 | 15.3 | 2.4 | 826 | 81.7 |
| SiMBA-B | 224 | 22.8 | 4.2 | 624 | 83.5 |
| VMamba-T | 224 | 30.0 | 4.9 | 1282 | 82.6 |
| VMamba-S | 224 | 50.0 | 8.7 | 843 | 83.6 |
| VMamba-B | 224 | 89.0 | 15.4 | 645 | 83.9 |
| MambaVision-T | 224 | 31.8 | 4.4 | 6298 | 82.3 |
| MambaVision-T2 | 224 | 35.1 | 5.1 | 5990 | 82.7 |
| MambaVision-S | 224 | 50.1 | 7.5 | 4700 | 83.3 |
| MambaVision-B | 224 | 97.7 | 15.0 | 3670 | 84.2 |
| MambaVision-L | 224 | 227.9 | 34.9 | 2190 | 85.0 |
| MambaVision-L2 | 224 | 241.5 | 37.5 | 1021 | 85.3 |

In downstream tasks such as object detection, instance segmentation, and semantic segmentation on MS COCO and ADE20K datasets, MambaVision variants outperform comparably sized backbones while demonstrating favorable performance. A comparison of object detection and instance segmentation benchmarks using Cascade Mask R-CNN on the MS COCO dataset is provided in Table 2 (all models are trained using a 3×schedule and a crop resolution of 1280×800).

TABLE 2

| | Params | FLOPs | | | | | | |
|---|---|---|---|---|---|---|---|---|
| Backbone | (M) | (G) | AP^{box} | AP₅₀^{box} | AP₇₅^{box} | AP^{mask} | AP₅₀^{mask} | AP₇₅^{box} |
| DeiT-Small/16 | 80 | 889 | 48.0 | 67.2 | 51.7 | 41.4 | 64.2 | 44.3 |
| ResNet-50 | 82 | 739 | 46.3 | 64.3 | 50.5 | 40.1 | 61.7 | 43.4 |
| Swin-T | 86 | 745 | 50.4 | 69.2 | 54.7 | 43.7 | 66.6 | 47.3 |
| ConvNeXt-T | 86 | 741 | 50.4 | 69.1 | 54.8 | 43.7 | 66.5 | 47.3 |
| Mamba Vision-T | 86 | 740 | 51.0 | 69.9 | 55.6 | 44.3 | 67.2 | 48.1 |
| X101-32 | 101 | 819 | 48.1 | 66.5 | 52.4 | 41.6 | 63.9 | 45.2 |
| Swin-S | 107 | 838 | 51.9 | 70.7 | 56.3 | 45.0 | 68.2 | 48.8 |
| ConvNeXt-S | 108 | 827 | 51.9 | 70.8 | 56.5 | 45.0 | 68.4 | 49.1 |
| Mamba Vision-S | 108 | 828 | 52.1 | 70.9 | 56.7 | 45.2 | 68.4 | 49.1 |
| X101-64 | 140 | 972 | 48.3 | 66.4 | 52.3 | 41.7 | 64.0 | 45.1 |
| Swin-B | 145 | 982 | 51.9 | 70.5 | 56.4 | 45.0 | 68.1 | 48.9 |
| ConvNeXt-B | 146 | 964 | 52.7 | 71.3 | 57.2 | 45.6 | 68.9 | 49.5 |
| Mamba Vision-B | 145 | 964 | 52.8 | 71.6 | 57.2 | 45.7 | 69.0 | 49.5 |

A comparison of semantic segmentation benchmarks with the UperNet model using the ADE20K dataset are provided in Table 3 (all models are trained using a crop resolution of 512×512).

TABLE 3

| Model | Params (M) | FLOPs (G) | IoU(ss/ms) |
|---|---|---|---|
| DeiT-Small/16 | 52 | 1099 | −/44.0 |
| Swin-T | 60 | 945 | 44.5/45.8 |
| ConvNeXt-T | 60 | 939 | −146.7 |
| MambaVision-T | 55 | 945 | 46.0/47.2 |
| Twins-SVT-B | 88.5 | — | 47.7/48.9 |
| Swin-S | 81 | 1038 | 47.6/49.5 |
| ConvNeXt-S | 82 | 1027 | —149.6 |
| MambaVision-S | 84 | 1029 | 48.2/49.7 |
| Twins-SVT-L | 133 | — | 48.8/50.2 |
| Swin-B | 121 | 1188 | 48.1/49.7 |
| ConvNeXt-B | 122 | 1170 | —/49.9 |
| MambaVision-B | 122 | 1290 | 49.1/50.2 |

The architecture of hybrid vision backbone 200, which includes one or more hybrid stages in which at least one SSM-based block precedes at least one transformer block, achieves a new Pareto front in terms of Top-1 accuracy and image throughput, outperforming Transformer and Mamba-based models by a significant margin. By providing at least one SSM-based block prior to at least one transformer block, no positional embedding need be appended to the input tokens of the at least one transformer block, as positional information is encoded in the output of the at least one SSM-based block. Furthermore, by positioning self-attention blocks in the final layers of the hybrid stages, the hybrid vision backbone's ability to capture long-range dependencies is significantly improved while efficiency is simultaneously maintained.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

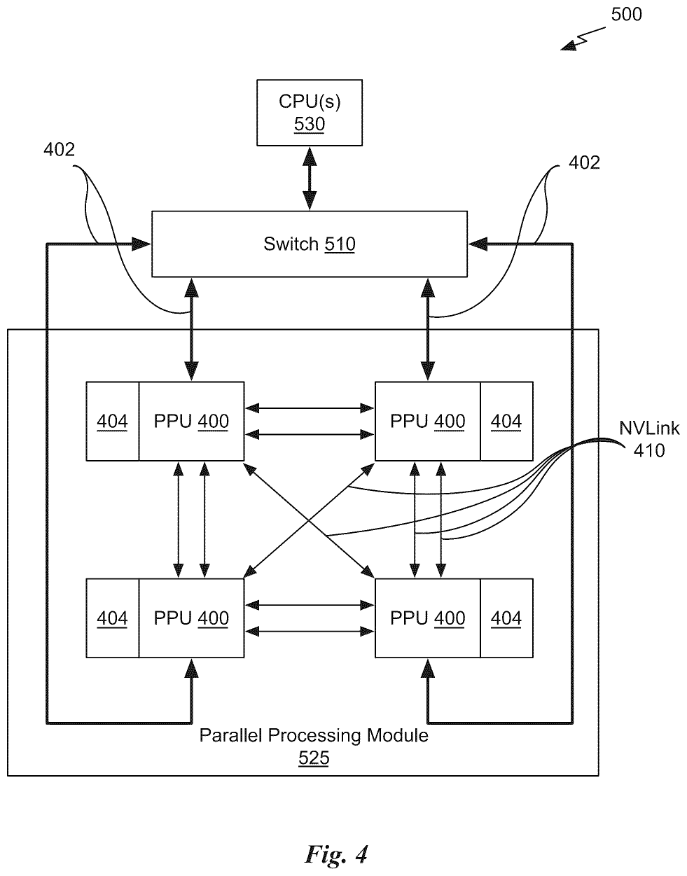

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

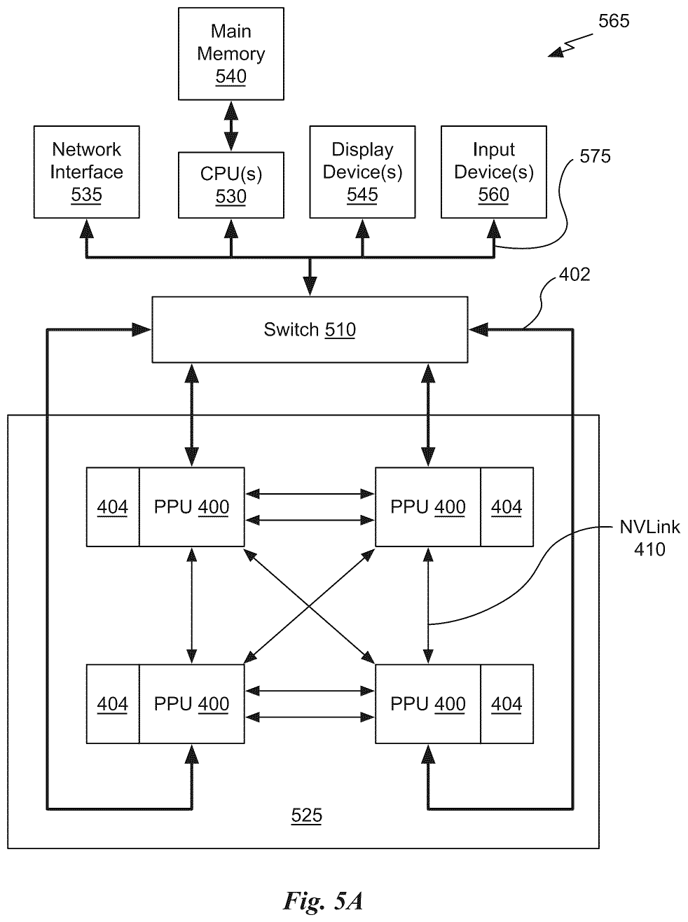

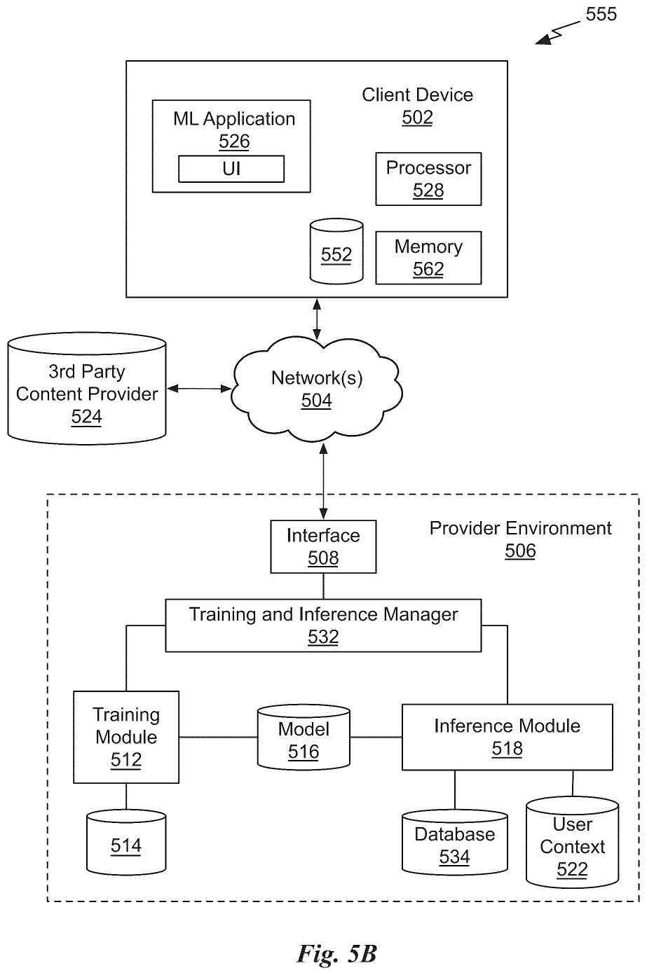

FIG. 5A illustrates an exemplary system 565 in which the various architecture and/or functionality of the various previous embodiments may be implemented. The exemplary system 565 may be configured to implement the method 300 shown in FIG. 3.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

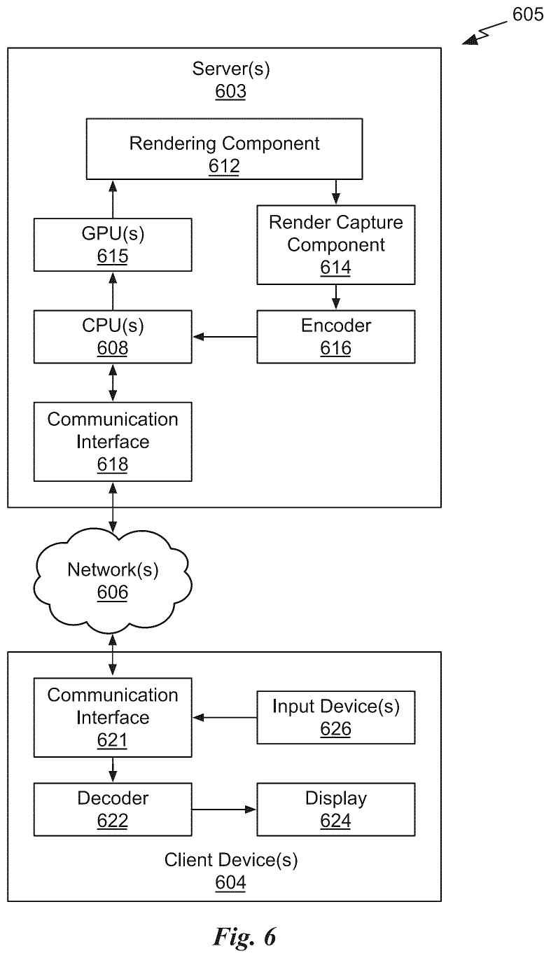

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A system comprising:
processing circuitry configured to use one or more neural networks to perform inference, the one or more neural networks comprising:
a state space model (SSM)-based block, the SSM-based block comprising:
a first branch comprising an SSM;
a second branch without an SSM; and
a concatenation layer configured to concatenate an output of the first branch and an output of the second branch; and
one or more memories to store the neural network.

2. The system of claim 1, wherein the SSM is configured to perform a scan operation that maps a respective token in a sequence of tokens provided to the SSM as input to a respective token in a sequence of tokens provided by the SSM as output via a respective hidden state.

3. The system according to claim 2, wherein the scan operation is a selective scan operation in which parameters of the respective hidden state are determined based on the respective input token.

4. The system according to claim 3, wherein the selective scan operation maps the sequence of input tokens to the sequence of output tokens via a hidden state according to:
$$h ( t ) = \overline{A} h ( t - 1 ) + \overline{B} x ( t )$$
$$y ( t ) = \overline{C} h ( t )$$
where x(t) is the sequence of input tokens, y(t) is the sequence of output tokens, h(t) is a sequence of latent states, Ã=exp(ΔA), B̅=(ΔA)⁻¹ (exp(ΔA)−I)·(ΔB), and the parameters B, C, and Δ are input-dependent.

5. The system of claim 1, wherein the first branch further comprises:
a first linear projection layer;
a first convolutional layer; and
a first activation function.

6. The system of claim 5, wherein the first linear projection layer is configured to receive SSM-based block input and project the SSM-based block input into a latent space to provide first linear projection layer output,
wherein the first convolutional layer is configured to receive the first linear projection layer output and apply a convolutional filter thereto to provide first convolutional layer output, and
wherein the first activation function is configured to receive the first convolutional layer output and apply a non-linear transformation to each element thereof to provide a sequence of tokens, and
wherein the SSM is configured to receive the sequence of tokens as input and to provide a second sequence of tokens that are provided as the output of the first branch.

7. The system of claim 6, wherein the second branch further comprises:
a second linear projection layer;
a second convolutional layer; and
a second activation function.

8. The system of claim 7, wherein the second linear projection layer is configured to receive the SSM-based block input and project the SSM-based block input into a latent space to provide second linear projection layer output,
wherein the second convolutional layer is configured to receive the second linear projection layer output and apply a convolutional filter thereto to provide second convolutional layer output, and
wherein the second activation function is configured to receive the second convolutional layer output and apply a non-linear transformation to each element thereof to provide a third sequence of tokens that are provided as the output of the second branch.

9. The system of claim 8, wherein the SSM-based block further comprises a third linear projection layer configured to receive the output of the concatenation layer and reduce the dimensionality of the output of the concatenation layer.

10. The system of claim 3, wherein the SSM-based block is configured to receive SSM-based block input and provide SSM-based block output according to:
$${X}_{1} = Scan ( σ ( Conv ( Linear ( C , \frac{C}{2} ) ( {X}_{in} ) ) ) ) ,$$
$${X}_{2} = σ ( Conv ( Linear ( C , \frac{C}{2} ) ( {X}_{in} ) ) ) ,$$
$${X}_{out} = Linear ( \frac{C}{2} , C ) ( Concat ( {X}_{1} , {X}_{2} ) ) ,$$
wherein Xᵢₙ is the SSM-based block input, Xₒᵤₜ is the SSM-based block output, Linear (Cᵢₙ, Cₒᵤₜ) denotes a linear layer with input embedding dimension Cᵢₙ and output embedding dimension Cₒᵤₜ, Scan(·) is the selective scan operation, σ is an activation function, Conv(·) is a 1D convolution operation, and Concat(·) is a concatenation operation.

11. A system comprising:
processing circuitry configured to use one or more neural networks to extract features from visual input, the one or more neural networks comprising:
at least one hybrid stage comprising one or more state space model (SSM)-based blocks and one or more transformer blocks, wherein at least one SSM-based block precedes at least one transformer block.

12. The system according to claim 11, wherein the one or more neural networks are configured to receive, as input, the visual input and to provide, as output, a sequence of tokens encoding feature information.

13. The system according to claim 11, the one or more neural networks comprising one or more second hybrid stages comprising one or more additional state space model (SSM)-based blocks and one or more additional transformer blocks, wherein at least one additional SSM-based block precedes at least one additional transformer block.

14. The system according to claim 13, wherein the at least one hybrid stage is configured to process the visual input at a first resolution, and
wherein the at least one second hybrid stage is configured to process the visual input at a second resolution.

15. The system according to claim 11, wherein the at least one SSM-based block is configured to perform a scan operation that maps a respective token in a sequence of input tokens to a respective token in a sequence of output tokens via a respective hidden state, wherein the respective sequence of output tokens encodes positional information, and wherein the at least one transformer block receives the sequence of output tokens as input.

16. The system according to claim 15, wherein no positional embedding is appended to the sequence of output tokens prior to their being received by the at least one transformer block as input.

17. The system according to claim 11, wherein the at least one SSM-based block comprises:
a first branch comprising an SSM;
a second branch without an SSM; and
a concatenation layer configured to concatenate an output of the first branch and an output of the second branch.

18. The system according to claim 17, wherein the SSM is configured to perform a scan operation that maps a respective token in a sequence of tokens provided to the SSM as input to a respective token in a sequence of tokens provided by the SSM as output via a respective hidden state.

19. The system according to claim 18, wherein the scan operation is a selective scan operation in which parameters of the respective hidden state are determined based on the respective input token.

20. The system according to claim 19, wherein the SSM-based block is configured to receive SSM-based block input and provide SSM-based block output according to:
$${X}_{1} = Scan ( σ ( Conv ( Linear ( C , \frac{C}{2} ) ( {X}_{in} ) ) ) ) ,$$
$${X}_{2} = σ ( Conv ( Linear ( C , \frac{C}{2} ) ( {X}_{in} ) ) ) ,$$
$${X}_{out} = Linear ( \frac{C}{2} , C ) ( Concat ( {X}_{1} , {X}_{2} ) ) ,$$
wherein Xᵢₙ is the SSM-based block input, Xₒᵤₜ is the SSM-based block output, Linear (Cᵢₙ, Cₒᵤₜ) denotes a linear layer with input embedding dimension Cᵢₙ and output embedding dimension Cₒᵤₜ, Scan(·) is the selective scan operation, σ is an activation function, Conv(·) is a 1D convolution operation, and Concat(·) is a concatenation operation.
